(19) United States
(12) Patent Application Publication
(10) Pub. No.: US 2016/0148326 A1
(43) Pub. Date: May 26, 2016

(54) GRAPHICAL USER INTERFACE COMPRISING MULTIPLE, INTERRELATED COMPONENTS GENERATED IN RESPONSE TO A DATA REQUEST

(71) Applicant: GOOGLE INC., Mountain View, CA (US)

(72) Inventors: Margaret Aycinena Lippow, San Francisco, CA (US); Naval Verma, Sunnyvale, CA (US)

(21) Appl. No.: 15/011,390

(22) Filed: Jan. 29, 2016

Related U.S. Application Data
(63) Continuation of application No. 13/862,358, filed on Apr. 12, 2013.
Application No. 13/862,358 is a division of application No. 13/182,403, filed on Jul. 13, 2011, now abandoned.

(51) Int. Cl. G06Q 50/12; G06Q 50/14; G06F 3/0482; G06F 17/30; G06F 3/0484; G06Q 10/02; G06Q 30/06

(52) U.S. Cl. CPC G06Q 50/12; G06Q 10/02; G06Q 50/14; G06Q 30/0631; G06F 17/3053; G06Q 30/0643; G06F 3/04842; G06F 3/0482

(57) ABSTRACT

Methods, systems, and apparatus, including computer programs encoded on a computer storage medium, for presenting graphical user interfaces comprising multiple interrelated components. In one aspect, a method includes receiving a user request for hotel booking condition information for a particular hotel for a particular date range and displaying the hotel data on the graphical user interface. The method includes determining a collection of candidate hotel suggestions for the particular date range, where the candidate hotel suggestions are located within a specified distance from the hotel, and where the candidate hotel suggestions are selected based at least in part on a specified condition; ranking the collection of candidate hotel suggestions based at least in part on a calculated value; and displaying, on a second section of the graphical user interface, the candidate hotel suggestions having a rank exceeding a specified threshold.

### CROSS-REFERENCE TO RELATED APPLICATIONS

This application is a continuation of U.S. patent application Ser. No. 13/862,358, filed on Apr. 12, 2013, entitled “Presenting Hotel Search Results,” which is a divisional application of and claims priority to U.S. patent application Ser. No. 13/182,403, filed on Jul. 13, 2011, entitled “Presenting Hotel Search Results.” The entire contents of the above-identified applications are hereby fully incorporated herein by reference.

### TECHNICAL FIELD

This specification relates to graphical user interfaces and, more specifically, to graphical user interfaces comprising multiple, interrelated components generated in response to a data request.

### BACKGROUND

Users can use various web sites to plan travel, including reserving hotel stays. Conventionally, a user navigates to either a web site corresponding to a particular entity (e.g., a site belonging to a specific hotel or hotel brand) or to a web-based travel booking site that provides access to several different hotels. The user desires to identify an itinerary for travel and receive a display of the hotel options.

### SUMMARY

This disclosure relates to methods to cause display devices to render graphical user interfaces comprising multiple, interrelated components generated in response to a data request.

In general, one aspect of rendering such graphical user interfaces described in this specification can be embodied in methods that include the actions of receiving a user request for hotel information for a particular hotel for a particular date range; determining a collection of candidate hotel suggestions for the particular date range, where the candidate hotel suggestions are located within a specified distance from the hotel, and where the candidate hotel suggestions are selected based at least in part on a specified condition; ranking the collection of candidate hotel suggestions based at least in part on a calculated value; and displaying to the user one or more candidate hotel suggestions from the collection of candidate hotel suggestions having a rank exceeding a specified threshold as alternative accommodations to the hotel. Other embodiments of this aspect include corresponding systems, apparatus, and computer program products.

These and other embodiments can optionally include one or more of the following features. The specified condition is satisfied in a case where the particular candidate hotel suggestion has an actual booking condition equal to or less than the average booking condition for the hotel; and an average booking condition equal to or greater than the actual booking condition for the hotel. The actual booking condition and the average booking condition for the hotel are adjusted. The specified condition is satisfied in a case where the actual booking condition of the candidate hotel suggestion falls within a threshold, where the threshold is determined using the actual booking condition of the hotel. The specified condition is satisfied in a case where the average booking condition of the candidate hotel suggestion falls within a threshold, where the threshold is determined using the adjusted average booking condition of the hotel.

The specified condition is satisfied in a case where the candidate hotel suggestion has an actual booking condition less than the actual price of the hotel, and where the candidate hotel suggestion has a caliber greater than a caliber of the hotel. The specified condition is satisfied in a case where a caliber of the candidate hotel suggestion falls within a threshold, where the threshold is determined using a caliber of the hotel. The caliber is calculated using the average booking condition and a star rating. The caliber is calculated using a star rating. The caliber is calculated using the average booking condition.

The collection of candidate hotel suggestions are ranked based at least in part on a calculated value which is calculated by determining an actual booking condition value, where the actual booking condition value is determined by calculating a difference between the actual booking condition of the candidate hotel suggestion and the actual booking condition of the hotel; determining an average booking condition value, where the average booking condition value is determined by calculating a difference between the average booking condition of the hotel and the average booking condition of the candidate hotel suggestion; and summing the actual booking condition value and the average booking condition value. The collection of candidate hotel suggestions are ranked based at least in part on a calculated value comprises sorting the candidate hotel suggestions in descending order by actual booking condition. The collection of candidate hotel suggestions are ranked based at least in part on a calculated value includes sorting the candidate hotel suggestions in ascending order by a caliber, where the caliber is computed using average booking condition.

In general, one aspect of the subject matter described in this specification can be embodied in methods that include the actions of determining an average booking condition of a hotel over a specified time period; determining an actual booking condition of the hotel for a particular date range; and calculating a deal score for the hotel, where the deal score is calculated using the hotel average booking condition and the hotel actual booking condition. Other embodiments of this aspect include corresponding systems, apparatus, and computer program products.

These and other embodiments can optionally include one or more of the following features. The steps of determining and calculating are performed for hotels for the particular date range, where the hotels satisfy a specified condition, and where the plurality of hotels are ranked relative to their deal scores. The deal score is calculated by calculating a difference between the hotel average booking condition and the hotel actual booking condition and dividing the difference by the hotel average booking condition. The deal scores are used to generate advertising content for hotels with availability within the particular date range. The calculated deal score and corresponding text-based representation of the deal score can be displayed.

Particular embodiments of the subject matter described in this specification can be implemented so as to realize one or more of the following advantages. Hotels determined to be a better deal relative to a query hotel can be presented as a better option. Hotels determined to be comparable to a query hotel can be suggested as alternatives to the query hotel. Hotels can be compared based on hotel caliber and pricing information. Relative pricing information between hotels can be determined. Deal scores for hotels can be calculated to assist users in deciding between two or more hotels. Deal scores can be calculated using pricing information for a hotel relative to that hotel's typical booking condition. In particular, deal scores can be used by a user to determine whether or not the particular booking condition is a good booking condition for that hotel.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example hotel search system.

FIG. 2 is a flow diagram of an example process for determining deal scores.

FIG. 3 is a flow diagram of an example process for suggesting alternative hotels.

FIG. 4 is an example hotel detail page showing deal information for a hotel.

FIG. 5 is an example hotel place page showing relative pricing information.

FIG. 6 is an example hotel results listing showing hotels and their deal scores.

FIG. 7 is an example hotel results listing showing advertisements for hotels.

FIG. 8 is an example maps place page for a hotel showing alternative hotels.

Like reference numbers and designations in the various drawings indicate like elements.

### DETAILED DESCRIPTION

Alternative hotel accommodations can be suggested for a query hotel, for a specified date range. A hotel suggested as an alternative to the query hotel can be of greater value than the query hotel or an option similar to the query hotel.

A suggested hotel can be identified based on hotel caliber and pricing information for the specified date range. Hotel caliber can be a measure of hotel quality and can be measured using a variety of quality indicators, for example, location, class, and user rating. In some implementations, hotel caliber is determined using hotel class ratings (e.g., a rating such as star level). In some other implementations, hotel caliber is determined based on a historical average price a hotel, where the historical average price provides an implicit indication of a hotel's quality as determined by market efficiency. In particular, where the market efficiency permits hotels to price themselves based on supply and demand.

In more detail, a hotel can be suggested as being of greater value if the hotel has both a higher caliber and the same price, for the specified date range, as the query hotel. A hotel can also be suggested as being of greater value if the hotel has both the same caliber and a better price, for the specified date range, than the query hotel. In addition, a hotel can be suggested as being of greater value if the hotel has a higher caliber and a better price, for the specified date range, than the query hotel. Hotels identified using these criteria can be presented to the user for consideration as alternative hotel choices.

A hotel can also be suggested as an alternative hotel if the hotel is a similar option to the query hotel. In this regard, a hotel can be suggested as a similar option if the hotel has both the same caliber and a worse price than the query hotel, for the specified date range. A hotel can also be suggested as a similar option if the hotel has both a lower caliber and the same price as the query hotel, for the specified date range. Alternative hotels determined using these criteria can be used to identify hotels that do not necessarily provide a greater value (e.g., as a function of caliber or price) than a query hotel, thereby providing the user with a comparison of all available hotels in terms of both caliber and price. For example, when all alternative hotels are determined not to be of greater value relative to a query hotel, a user can conclude that the query hotel is the best deal available for the specified date range.

Suggested hotels can be presented to users in connection with hotel search results. For example, hotel search results can be presented in response to a user query. A user selection of a particular hotel from the presented hotel search results for a specified date range may result in display of a hotel place page for the query hotel. The hotel place page can include suggestions for alternative hotels for the specified date range.

In some implementations, a deal score can be calculated for one or more hotels for a specified date range. The deal score can reflect whether a query hotel is a good deal for a specified date range relative to the historical average price for the query hotel. Additionally, the deal score can reflect whether a query hotel is a good deal relative to nearby hotels for a specified date range.

Deal scores can also be presented to users in the hotel search results listing, where the deal score for each hotel search result is displayed. A deal score can also be presented in connection with a hotel place page, thereby providing a user with an indication as to the value of a particular hotel relative to nearby hotels, or whether the particular hotel is a good deal for the specified date range relative to its own average price.

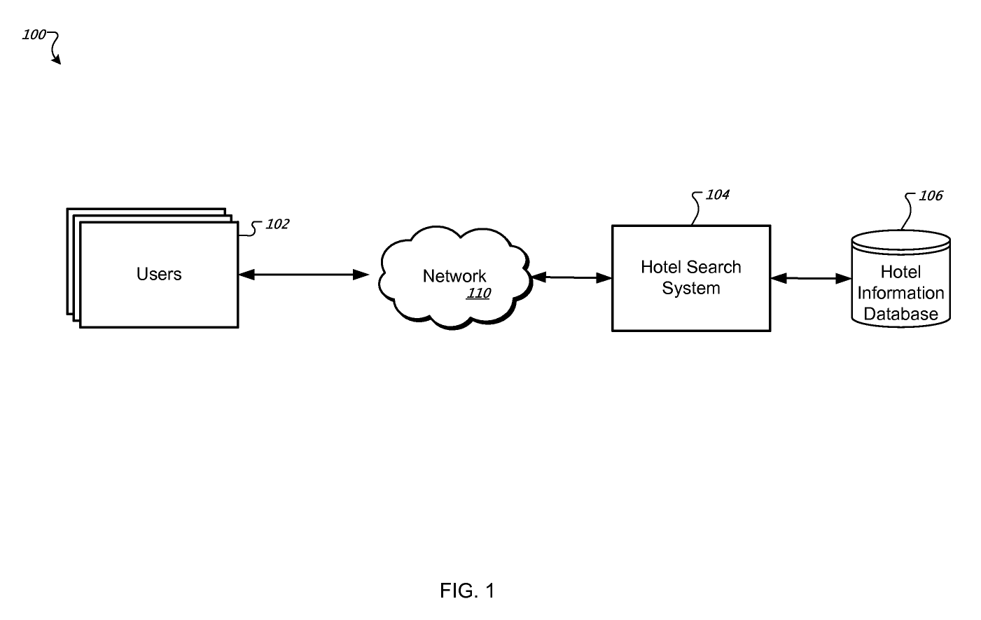

FIG. 1 is a block diagram of an example hotel search system 100. The hotel search system 100 includes a hotel search system 104 in communication with one or more users 102 through a network 110. In particular, the hotel search system 104 obtains information from a hotel database 106 in order to suggest hotels and to provide hotel deals in connection with search results to requesting users 102. The hotel database 106 can store, for example, a listing of hotels for which pricing is to be presented, corresponding actual and historical pricing information, dates of availability, and hotel class (e.g., a rating such as star level). Historical pricing information can contain a calculated average of a hotel's prices for a particular date range, and it can also contain raw pricing information of a hotel's cost per day. The term “hotel” as used in the specification can refer generically to various types of accommodations including hotels, motels, lodges, or resorts.

The network 110 can be a local area network (LAN), a wide area network (WAN), the Internet, one or more telephony or wireless networks, or a combination thereof.

The hotel search system 104 uses the obtained hotel information to suggest alternative hotel accommodations for a query hotel within a specified date range. Suggested alternative hotels can be options of similar or greater value to the query hotel for the specified date range. The hotel search system 104 can also use the obtained hotel information to determine a deal score for one or more hotels relative to a historical average price for the respective hotel.

The hotel search system 104 uses the obtained hotel information to present hotel information and hotel deal results responsive to a received search query. For example, the hotel search system 104 can present hotel information for a query hotel along with suggestions for alternative accommodations and deal scores. A hotel can be selected from a hotel search interface, a hotel search results listing, or from a hotel place page. For example, a user query or specification of one or more hotel parameters can be used to identify and provide a collection of hotel results from which the user can select.

The hotel search system 104 can provide alternative hotels and deal scores to the requesting user 102 through the network 110. In some implementations, suggested alternative hotels and deal scores are presented alongside hotel information for one or more hotels responsive to the query. In some other implementations, alternative hotels, including the query hotel, are ranked based on caliber and pricing information for a specified date range. In yet some other implementations, alternative hotels, including the query hotel, are ranked based on their respective deal scores for a specified date range.

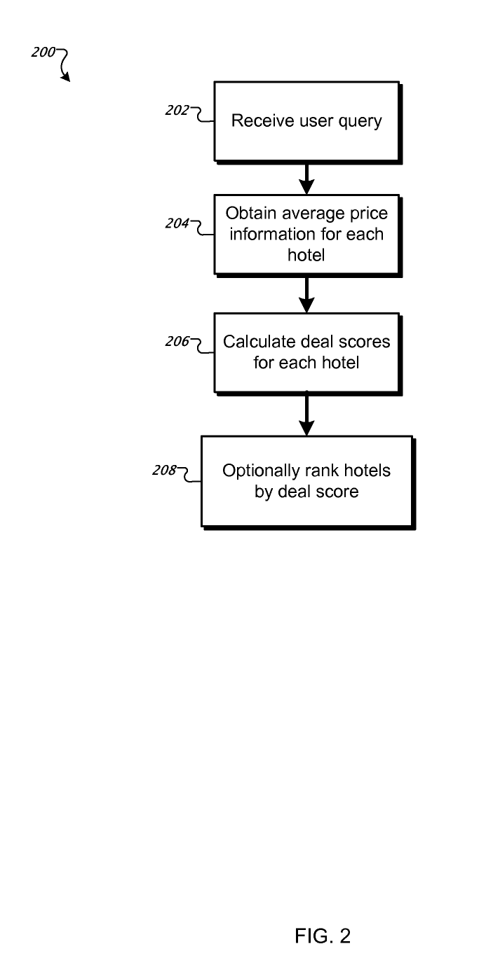

FIG. 2 is a flow diagram of an example process 200 for determining hotel value using deal scores. For convenience, the process 200 will be described with respect to a system (e.g., hotel search system 104) including one or more computing devices that performs the process 200.

The deal score provides a measurement for determining hotel value using the historical average price percentage difference for each hotel. Consequently, the deal score can be used to determine whether a particular hotel is a greater value in comparison to other hotels by comparing the deal score of that hotel against deal scores for the other hotels. The deal score can also be used to determine whether the actual price of a particular hotel is a good value in comparison to its own historical average price.

The system receives a query for hotels based on various criteria (e.g., location, quality, and amenities) for a specified date range (202). The query can be submitted to the system by a user (e.g., user 102) using a hotel search interface.

The system obtains historical average pricing information for one or more hotels responsive to the user's query (204). In some implementations, the historical average price for hotels is computed in advance for each hotel. Each hotel's historical average price can be computed in advance for every possible arrival date and length of stay over a period of time (e.g., one year of arrival days). This computation is performed for each hotel partner in order to determine the lowest possible price for each hotel across all hotel partners. Using this information, the system determines the median, 5th and 95th percentiles for each hotel and hotel partner.

Accordingly, in step 204, the system obtains historical pricing information for hotels by looking up the historical pricing information (e.g., from the hotel information database 106) for the user's arrival date and length of stay for each hotel. In particular, the system obtains the historical pricing information for the hotel, arrival date, and length of stay that was available a specified number of days before the arrival date, thereby accounting for pricing discrepancies that may arise in connection with the timing of making the hotel reservation for that arrival date. For example, hotel prices for a given arrival date may vary based on when a hotel reservation was actually made (e.g., a reservation made 30 days in advance for a given arrival date may differ than a reservation made 5 days in advance of the arrival date). In some implementations, the system accounts for such variations by obtaining historical pricing information for the user's arrival date and length of stay 20 days in advance of the user's arrival date.

The system calculates a deal score for hotels determined to be responsive to the user's query (206). In some implementations, the deal score is an independent metric that seeks to determine the value of a hotel using historical average pricing information and actual pricing information. As indicated above, historical average pricing information can provide an indication of hotel caliber as determined by market efficiency.

One example mathematical formula for determining a deal score is:

$$\frac{( μ - p )}{μ}$$

where μ is the historical average price for the hotel, and where p is the actual price, for the specified date range, for the hotel.

In some implementations, this example formula is used to determine whether the actual price of a particular hotel for a specified date range is a good value in comparison to that hotel's historical average price. For example, a higher deal score suggests that the current actual price of a hotel is a good value based on that hotel's typical price. Similarly, a lower deal score suggests that a hotel may not be a good value based on that hotel's typical price. In some other implementations, this example formula is used to determine whether a particular hotel is a greater value in comparison to other hotels, as discussed in more detail in step 208.

The system optionally ranks the hotels by deal score (208). As noted earlier, the deal score can also be used as a metric for comparing the value of hotels across a specified date range by ranking the hotels using the previously calculated deal scores. One example mathematical formula for ranking hotels, based on whether a particular hotel has a higher deal score relative to another hotel's deal score, is:

$$\frac{( {μ}_{1} - {p}_{1} )}{{μ}_{1}} > \frac{( {μ}_{2} - {p}_{2} )}{{μ}_{2}}$$

where μ₁ and p2 are the actual prices, for the specified date range, for a first hotel and for a second hotel, respectively, and where μ₁ and μ₂ are the historical average prices for the first hotel and for the second hotel, respectively.

This example formula can be used to rank hotels by deal score, such that hotels having a higher ranking are considered to be of a greater value than hotels having a lower ranking. For example, when two hotels have a similar average price (e.g., μ₁≈μ₂), the hotel having a lower price (e.g., p₁<p₂) will have a higher deal score, and thus be deemed a greater value. In another example, when two hotels have a similar actual price (e.g., p₁≈p₂), the hotel having a higher average price (e.g., μ₁>μ₂) will have a higher deal score, and thus be deemed a greater value. In yet another example, a hotel having both a lower actual price (e.g., p₁<p₂) and a higher average price (e.g., μ₁>μ₂) than another hotel will have a higher deal score, and thus be deemed a greater value.

In some implementations, the hotel search results listing presents the ranked list of hotels by deal score. In some other implementations, deal scores are listed in hotel place pages. In some alternative implementations, deal information can be provided within a hotel place page, where the deal information can provide a numerical deal score, a text-based representation of the deal score, or a combination of the two. In yet some other implementations, a user can be presented with one or more advertisements for each of the hotels along with their deal score.

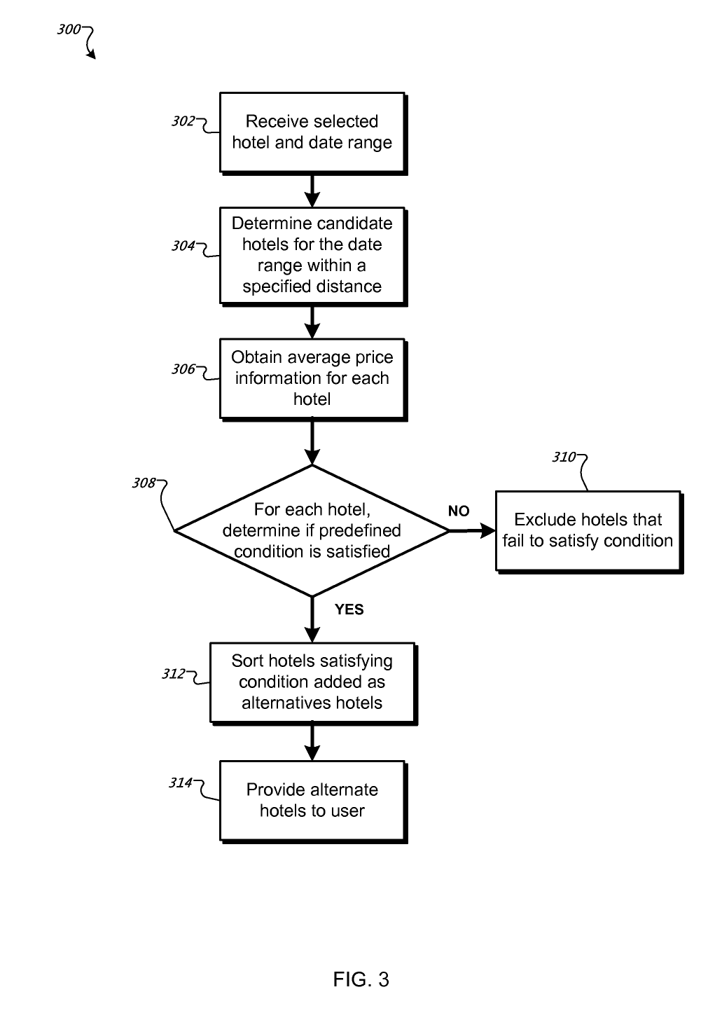

FIG. 3 is a flow diagram of an example process 300 for suggesting alternative hotels for a query hotel. For convenience, the process 300 will be described with respect to a system (e.g., hotel search system 104) including one or more computing devices that performs the process 300.

The system receives a query hotel and a specified date range (302). Selection of a hotel and specification of a date range can be determined by a user (e.g., user 102) using a hotel search interface. The query hotel and date range can be provided to the system as part of a user input to the hotel search interface. The query hotel and date range can also be identified based on, for example, a user's selection of the hotel from a hotel search results listing or from a hotel place page.

The system determines candidate hotel suggestions for the specified date range that are located within a specified distance from the query hotel (304). For example, using information from a hotel database (e.g., hotel database 106), the system can select the first 100 hotels that are within 20 miles of the query hotel as candidate hotel suggestions. In some implementations, the distance radius is specified by the user, such that the user designates the search radius to be used for identifying alternative hotels.

In some alternative implementations, the distance radius is specified by the hotel search system, which takes a density of hotels in a geographical location into account. In particular, using hotel location information from a hotel database (e.g., hotel database 106), the system can calculate the number of hotels that fall within various distances from the query hotel (e.g., 1 mile, 3 miles, 5 miles), and use that calculation to determine a distance radius for identifying alternative hotels. In some implementations, the distance radius is selected based on the number of hotels that fall within a particular distance. For example, the hotel search system can recognize that hotels within a three mile radius of a query hotel in Napa Valley can be considered as viable alternatives based on the density of hotels within that distance radius. However, in a case where the query hotel is in Manhattan, the hotel search system can recognize that hotels within a three mile radius may not be seen as viable alternatives based on the density of hotels within that distance radius.

In some implementations, the number of candidate hotel suggestions is specified by the user, such that the user controls how many candidate hotel suggestions will be considered as possible alternatives to the query hotel. In some other implementations, the system specifies the number of candidate hotel suggestions based on the density of hotels within a distance radius. In determining candidate hotel suggestions, the system can filter the candidate hotel suggestions, for example, by excluding hotels for which a historical average price is not available or hotels that do not have availability for the specified date range.

The system obtains historical average pricing information for each candidate hotel suggestion (306). In some implementations, the historical average price for hotels is computed in advance for each hotel. Each hotel's historical average price is computed in advance for multiple arrival dates and lengths of stay over a period of time (e.g., one year of arrival dates). This computation is performed for each hotel partner in order to determine the lowest possible price for each hotel across all hotel partners. Using this information, the system determines the median, 5th and 95th percentiles for each hotel and hotel partner.

Accordingly, in step 306, the system obtains historical pricing information for hotels by looking up the historical pricing information (e.g., from the hotel information database 106) for the user's arrival date and length of stay for each hotel. In particular, the system obtains the historical pricing information for the hotel, arrival date, and length of stay that was available a specified number of days before that arrival date. Consequently, pricing discrepancies that may arise in connection with the timing of making the hotel reservation for that arrival date can be taken into account. For example, hotel prices for a given arrival date may vary based on when a hotel reservation was actually made (e.g., a reservation made 30 days in advance for a given arrival date may differ than a reservation made 5 days in advance of the arrival date). In some implementations, the system accounts for such variations by obtaining historical pricing information for the user's arrival date and length of stay 20 days in advance of the user's arrival date.

Hotel partners can be, for example, a provider for a specific hotel or hotel chain as well as third party providers that support hotel bookings for many different hotels. In some implementations, actual pricing information and historical average pricing for hotels are reflected in a preferred currency, as identified by a user or as determined based on the country from where the user's query originated. In other implementations, the historical average pricing information is computed in advance and stored for later reference.

The system determines whether each candidate hotel suggestion qualifies as an alternative hotel based on one or more specified conditions (308). If a candidate hotel suggestion satisfies the one or more specified conditions, the candidate hotel suggestion is added to the list of alternative hotels (312). If a candidate hotel suggestion does not satisfy the one or more specified conditions, the candidate hotel suggestion is excluded from the list of alternative hotels (310). In some implementations, the one or more specified conditions require that a candidate hotel suggestion have a similar historical average price to the query hotel, or that a candidate hotel suggestion have a similar actual price to the query hotel, or that a candidate hotel suggestion have a lower actual price and a higher historical average price than the query hotel.

Example mathematical formulas for these conditions are provided below:
Similar historical average price:

(1−w)μ_{q}≦μₛ≦(1+w)μ_{q}
where μₛ and μ_{q} are the historical average prices for the candidate hotel suggestion and for the query hotel, respectively, and where w is a variable to allow deviation in pricing information.
Similar actual price:

(1−w)p_{q}≦pₛ≦(1+w)p_{q}
where pₛ and p_{q} are the actual prices, for the specified date range, for the candidate hotel suggestion and for the query hotel, respectively, and where w is a variable to allow deviation in pricing information.
Lower actual price and higher historical average price:

pₛ≦(1+w)p_{q} and μₛ≧(1−w)μ_{q}
where μₛ and μ_{q} are the historical average prices for the candidate hotel suggestion and for the query hotel, respectively, and where pₛ and p_{q} are the actual prices, for the specified date range, for the candidate hotel suggestion and for the query hotel, respectively, and where w is a variable to allow deviation in pricing information.

The system can use the conditions (calculated, for example, using the mathematical formulas listed above) to determine whether the candidate hotel suggestion qualifies as an alternative hotel. When the query hotel is not available for the specified date range, the system can use the historical average price (μ_{q}) for the query hotel in place of its actual price (p_{q}) for the specified date range, thereby allowing the system to determine alternative hotel options for a query hotel that is not available for the given date range. Actual prices for hotels can be obtained from the hotel database.

As indicated above, the hotel historical average prices can be computed in advance for specified time periods (e.g., the average price over the last 6 months) and stored for later reference. One example format for storing historical average pricing information is presented below:

<hotel_id>:<hotel partner>--

<total_price_median>:<total_price_5th_percentile>:<total_price_95th_percentile>:

<base_price_median>:<base_price_5th_percentile>:<base_price_95th_percentile>:

<currency>:<number_of_samples>

According to this format, historical average pricing information is stored for each

hotel (“<hotel_id>”), where hotel entries are paired with hotel partners (“<hotel partner>”). Each hotel and hotel partner pair (“<hotel_id>:<hotel partner>”) is associated with historical average pricing information reflecting the median, 5th, and 95th percentiles for the total price of the hotel and base price for each day, where the base price reflects the cost of the room excluding taxes and fees. In addition, the pricing information for each pair is associated with the type of currency being used (“<currency>”), and the number of pricing samples (“number_of_samples”) that were used to determine the historical average pricing information.

The system sorts the hotels identified as alternative hotels by computing a ranking metric for each alternative hotel with respect to the query hotel (312). The sorting process factors in the historical average price differences and the actual price differences between the alternative hotel and the query hotel. Results from the sorting process can rank alternative hotels based on the actual price of the alternative hotel versus what a hotel stay in the alternative hotel is actually worth for the given date range. As a result, alternative hotels that are a worse option than the query hotel are demoted in rank. As discussed above, the actual worth of a particular hotel can be determined using historical average price information. One example mathematical formula for sorting hotels, based on whether a particular hotel's calculated score is higher than another hotel's calculated score, is:

(pₛ₁−p_{q})+(μ_{q}−μₛ₁)>(pₛ₂−p_{q})+(μ_{q}−μₛ₂)
where pₛ₁ and p_{q} are the actual prices, for the specified date range, for a first alternative hotel and for the query hotel, respectively, where μₛ₁ and μ_{q} are the historical average prices for the first alternative hotel and for the query hotel, respectively, and where pₛ₂ and μₛ₂ is the actual price and the historical average price, respectively, for a second alternative hotel.

Since the actual price and the historical average price for the suggested hotel remain constant for each ranking comparison, the sorting is equivalent to sorting each alternative hotel based on the actual price of that hotel versus its determined worth. Accordingly, alternative hotels can also be sorted using the following example mathematical formula, which is based on whether a particular hotel's calculated score is higher than another hotel's calculated score:

μₛ₁−pₛ₁>μₛ₂−pₛ₂
where μₛ₁ and μₛ₂ are the historical average prices for a first and second alternative hotel, respectively, and where pₛ₁ and pₛ₂ are the actual prices, for the specified date range, for the first and second alternative hotels, respectively.

There are several approaches available for suggesting alternative hotels, which will each be described in turn below.

Approach 1

In some implementations, the specified conditions in step 308 require that a candidate hotel suggestion have at least one of a similar actual price to the query hotel, a similar caliber to the query hotel, or a lower actual price and a higher caliber than the query hotel. In some implementations, the caliber is determined using both historical average price and hotel class (e.g., star level rating). In this regard, hotel class can indicate a hotel quality rating, as determined by an authoritative body, or a similar rating determined based on user reviews. Two hotels are similar in caliber if they are equal in average price and star level rating, with some deviation allowed in determining equivalency in average pricing. In addition, a first hotel is higher in caliber than a second hotel if the first hotel has a better average price and also has a better star level rating. Consequently, the sorting performed in step 312 seeks to rank alternative hotels based on an overall value of the hotels, where the sorting is used to identify hotels that are better in quality, lower in price, or both. One example mathematical formula for sorting hotels based on value, based on whether a particular hotel's calculated score is higher than another hotel's calculated score, is:

(pₛ₁−p_{q})+(μ_{q}−μₛ₁)>(pₛ₂−p_{q})+(μ_{q}−μₛ₂)
where pₛ₁ and p_{q} are the actual prices, for the specified date range, for a first alternative hotel and for the query hotel, respectively, where μₛ₁ and μ_{q} are the historical average prices star level ratings for the first alternative hotel and for the query hotel, respectively, and where pₛ₂ and μₛ₂ is the actual price and the historical average price, respectively, for a second alternative hotel.

Using this approach, the hotel search system seeks to identify hotel alternatives that are of similar or greater value to a query hotel.

Approach 2

In some other implementations, the specified conditions in step 308 require that a candidate hotel suggestion have a lower actual price and a higher caliber than the query hotel. The caliber is determined using hotel class (e.g., a rating such as star level rating). A first hotel is higher in caliber than a second hotel if the first hotel has a better star level rating. As discussed above, hotel class can indicate a hotel quality rating, as determined by an authoritative body, or a similar rating determined based on user reviews. The sorting performed in step 312 seeks to rank alternative hotels based on an overall value of the hotels, where the sorting is used to identify hotels that are better in quality, lower in price, or both. One example mathematical formula for sorting hotels based on value, based on whether a particular hotel's calculated score is higher than another hotel's calculated score, is:

(pₛ₁−p_{q})+(μ_{q}−μₛ₁)>(pₛ₂−p_{q})+(μ_{q}−μₛ₂)
where pₛ₁ and p_{q} are the actual prices, for the specified date range, for a first alternative hotel and for the query hotel, respectively, where μₛ₁ and μ_{q} reflect the hotel class for the first alternative hotel and for the query hotel, respectively, and where μₛ₂ and μₛ₂ is the actual price and the historical average price, respectively, for a second alternative hotel.

The hotel search system can indicate the filtering criteria used to a user. For example, a user viewing a hotel place page for a query hotel can be presented with information for nearby hotels that are viable alternatives (e.g., “Nearby available values under $150/night, 3+ stars”). Since hotels are ranked based on a hotel's discount from its historical average price, users can be provided justification for a hotel suggestion (e.g., “$70 below typical price”). As a result, this approach can be used to provide users with simple explanations for suggested alternative hotels while also optimizing the suggested alternatives based on hotel caliber and price.

Approach 3

In some alternative implementations, the specified conditions in step 308 require that a candidate hotel suggestion have a similar historical average price to the query hotel. Consequently, the sorting performed in step 312 seeks to rank alternative hotels by decreasing actual price. As a result, this approach can be used to provide users with suggestions for hotels that are similar in average price while also optimizing the suggestions by price.

Approach 4

In some other implementations, the specified conditions in step 308 require that a candidate hotel suggestion have a similar actual price as the query hotel. Thus, the sorting performed in step 312 seeks to rank alternative hotels by increasing historical average price. As a result, this approach can be used to provide users with suggestions for hotels that are similar in price while also optimizing the suggestions by average price.

The system presents the list of alternative hotels to the user for consideration (314). In some implementations, the suggested alternative hotels are displayed as a ranked list within a hotel place page for the query hotel. In some other implementations, a user is presented with one or more advertisements for each of the alternative hotels.

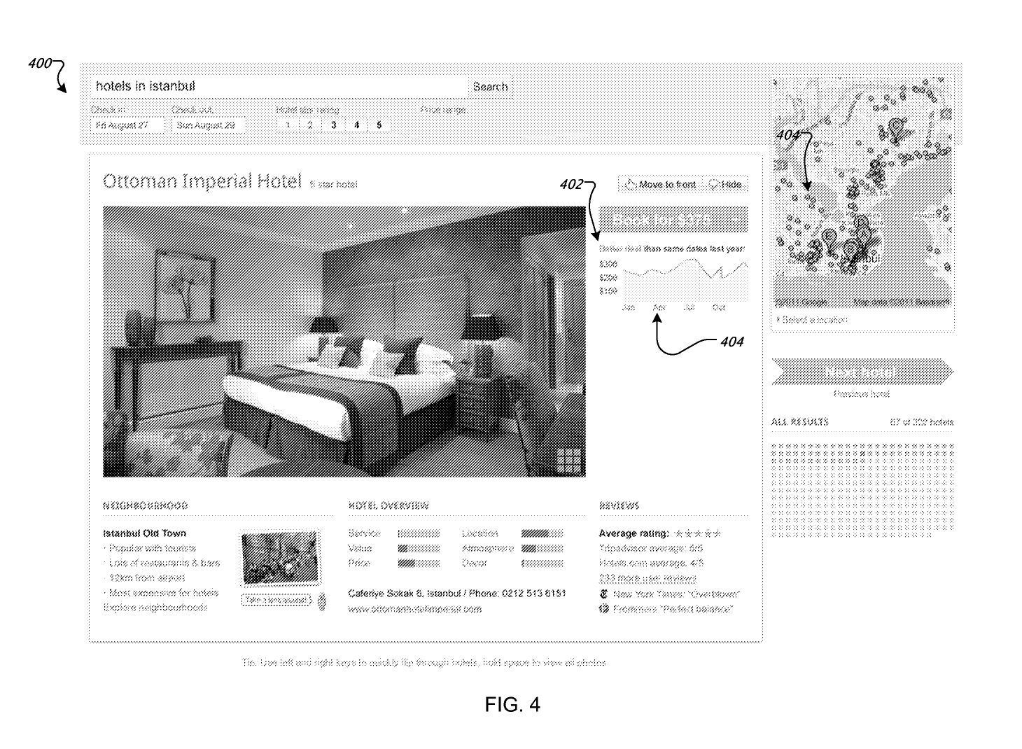

FIG. 4 is an example hotel detail page 400 showing deal information for a hotel. The hotel detail page 400 includes deal information 402 in the form of a text-based representation of the deal score (e.g., “Better deal than same dates last year”). The hotel detail page 400 also includes a graph 404 indicating pricing information for the query hotel over a period of time. The graph 404 allows users to compare how the hotel's actual price compares with its historical pricing. In particular, the graph 404 provides additional information to aid a user in deciding whether or not to book the hotel for the specified date range.

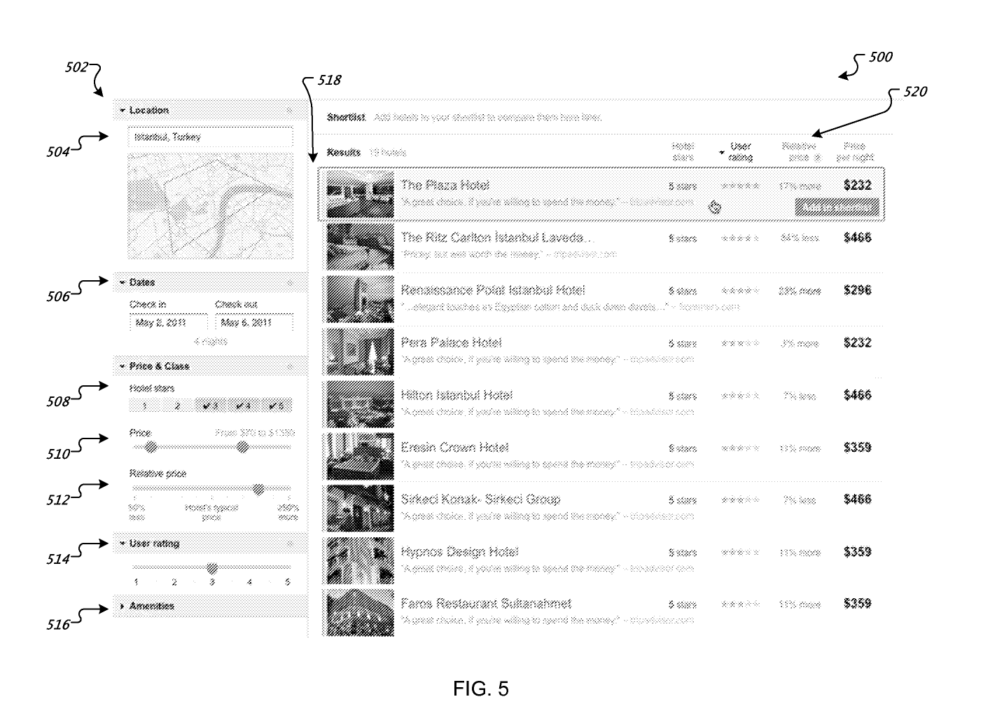

FIG. 5 is an example hotel results listing 500 showing relative pricing information. The hotel results listing 500 includes a list of hotels including hotel name, snippets of corresponding hotel reviews, class (e.g., star level), user rating, relative price (or deal score), and price per night. The hotel place page 500 depicts a search filter 502 for filtering hotel results based on location 504, date range 506, hotel class (e.g., star level) 508, actual price 510, relative price (or deal score) 512, user rating 514, and amenities 516. In particular, the deal scores provide an indication of a hotel's deal relative to its historical average pricing information. For example, the hotel place page 500 shows hotel 518 having a relative price (or deal score) 520 that is 17 percent more than its historical average price. The relative price (or deal score) 512 can be used to filter the hotel search results listing, thereby allowing users to identify hotels determined to be of greater value.

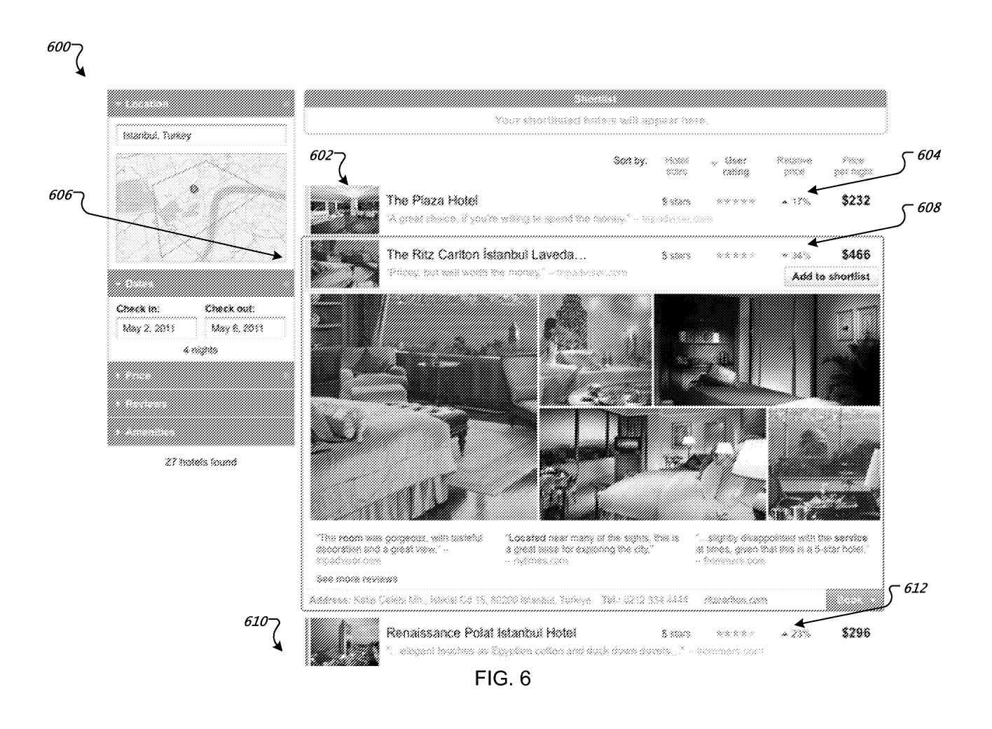

FIG. 6 is an example hotel place page 600 showing hotels and their deal scores. The hotel place page 600 includes a list of hotels including hotels 602, 606 and 610. The list of hotels includes, for each hotel, the hotel name, snippets of corresponding hotel reviews, class (e.g., star level), user rating, relative price (or deal score) and price per night. Hotel 606 has been selected and expanded to display additional information including images of the hotel and additional review snippets. In particular, the deal scores 604, 608, and 612 corresponding to hotels 602, 606, and 610, respectively, provide an indication of a hotel's value relative to its historical average pricing information. The hotel place page 600 indicates that the actual price for hotel 602 is 17 percent higher (604) than its average price. The hotel place page 600 also indicates that the actual price for hotel 606 is 34 percent less (608) than its average price. In addition, the actual price for hotel 610 is shown as being 23 percent higher (612) than its average price.

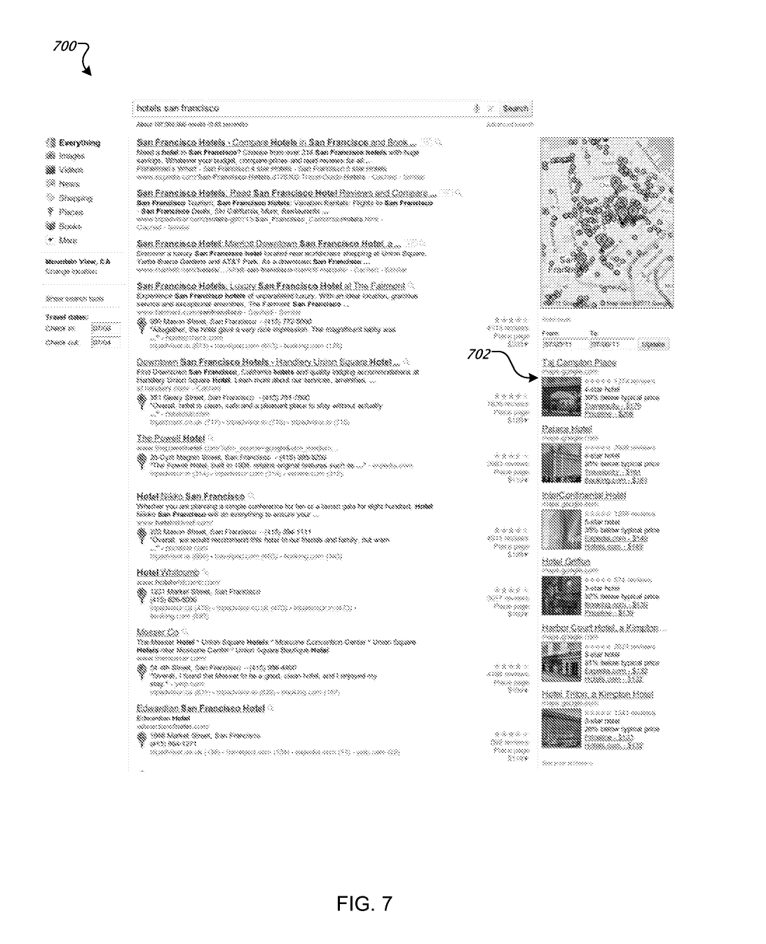

FIG. 7 is an example hotel results listing 700 showing advertisements for hotels. The hotel results listing 700 includes hotel advertisements 702. The advertisement for each hotel includes a hotel name, class (e.g., star level), user rating, relative price (or deal score) and price per night.

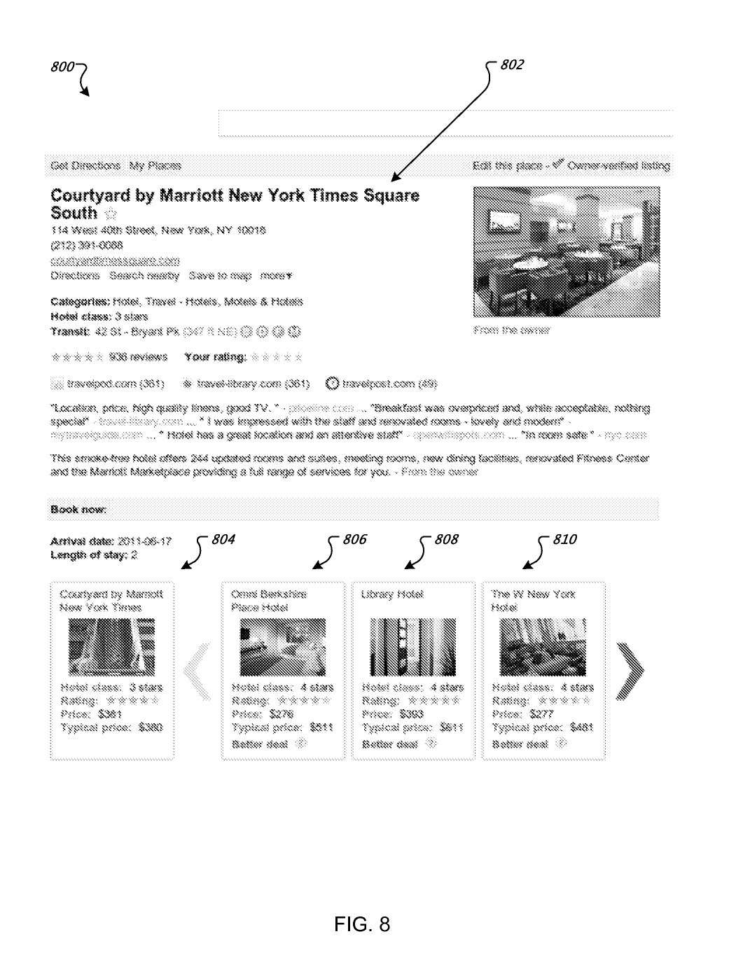

FIG. 8 is an example maps place page 800 for a hotel showing alternative hotels. The maps place page shows hotel information for hotel 802 including hotel name, class (e.g., star level), user rating, and snippets of user reviews. A summary window 804 for hotel 802 is also shown. The summary window for hotel 804 includes hotel name, class (e.g., star level), user rating, price per night, and typical price. Summary windows for suggested alternative hotels 806, 808, and 810 are also shown. In particular, summary windows for each of the suggested alternative hotels include hotel name, class (e.g., star level), user rating, price per night, typical price, and deal information in the form of a text-based representation of the deal score (e.g., “Better deal”). The deal information indicates that the suggested alternative hotels 806, 808, and 810 are better deals in comparison to hotel 802.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method to render graphical user interfaces comprising multiple, interrelated components generated in response to a data request, comprising:
receiving, by one or more user interface processors, a user request for information for a particular hotel for a particular date range from an input to a graphical user interface of a user computing device; and
providing, by one or more user interface processors, instructions causing the user computing device to render a graphical user interface, the graphical user interface comprising:
a hotel place page for the particular hotel in a first portion of the graphical user interface, the hotel place page comprising information identifying the particular hotel; and
a summary window for each of one or more candidate alternative hotels selected as alternative accommodations to the particular hotel in a second portion of the graphical user interface, the one or more candidate alternative hotels being selected by:
determining historical hotel data of the particular hotel over a specified time period;
determining current hotel data of the particular hotel for the particular date range;
calculating a score for the particular hotel, where the score is calculated using the historical hotel data and the current hotel data,
identifying a plurality of hotels that are each located within a specified distance from the particular hotel,
determining average historical hotel data for each identified hotel over the specified time period;
determining current hotel data for each identified hotel for the particular date range;
calculating a score for each identified hotel, where each of the scores is calculated using the average historical hotel data and the current hotel data of each identified hotel;
ranking, by the one or more processors, the candidate alternative hotels in the collection of candidate alternative hotels based at least in part on the respective scores for each of the candidate alternative hotels; and
selecting, by one or more user interface processors, one or more candidate alternative hotels from the collection of candidate alternative hotels having a rank exceeding a configured threshold as alternative accommodations to the particular hotel for presentation in the summary window of the second portion of the graphical user interface.

2. The method of claim 1, wherein calculating the score comprises:
calculating a difference between the historical hotel data and the current hotel data; and
dividing the difference by the historical hotel data.

3. The method of claim 1, wherein the scores are used to generate advertising content for hotels with availability within the particular date range.

4. The method of claim 1, wherein the graphical user interface displays the scores for the particular hotel and the one or more candidate alternative hotels.

5. A system, comprising:
one or more computing devices operable to perform operations to render graphical user interfaces comprising multiple, interrelated components generated in response to a data request, comprising:
receiving a user request for information for a particular hotel for a particular date range from an input to a user interface of a user computing device;
providing, by one or more user interface processors, instructions causing the user computing device to render a graphical user interface, the graphical user interface comprising:
a hotel place page for the particular hotel in a first portion of the graphical user interface, the hotel place page comprising information identifying the particular hotel; and
a summary window for each of one or more candidate alternative hotels selected as alternative accommodations to the particular hotel in a second portion of the graphical user interface, the one or more candidate alternative hotels being selected by:
determining historical hotel data of the particular hotel over a specified time period;
determining current hotel data of the particular hotel for the particular date range;
calculating a score for the particular hotel, where the score is calculated using the historical hotel data and the current hotel data,
identifying a plurality of hotels that are each located within a specified distance from the particular hotel,
determining average historical hotel data for each identified hotel over the specified time period;
determining current hotel data for each identified hotel for the particular date range;
calculating a score for each identified hotel, where each of the scores is calculated using the average historical hotel data and the current hotel data of each identified hotel;
ranking, by the one or more processors, the candidate alternative hotels in the collection of candidate alternative hotels based at least in part on the respective scores for each of the candidate alternative hotels; and
selecting, by one or more user interface processors, one or more candidate alternative hotels from the collection of candidate alternative hotels having a rank exceeding a configured threshold as alternative accommodations to the particular hotel for presentation in the summary window of the second portion of the graphical user interface.

6. The system of claim 5, wherein calculating the deal score comprises:
calculating a difference between the historical hotel data and the current hotel data; and
dividing the difference by the current hotel data.

7. The system of claim 5, wherein the scores are used to generate advertising content for hotels with availability within the particular date range.

8. The system of claim 5, wherein the graphical user interface displays the scores for the particular hotel and the one or more candidate alternative hotels.

9. A computer storage medium encoded with a computer program, the program comprising instructions that when executed by data processing apparatus cause the data processing apparatus to render graphical user interfaces comprising multiple components interrelated such that inputs received in one component of the graphical user interface render automatic and corresponding updates for another component of the graphical user interface to present hotel data, comprising:
receiving a user request for information for a particular hotel for a particular date range from an input to a user interface of a user computing device;
providing, by one or more user interface processors, instructions causing the user computing device to render a graphical user interface, the graphical user interface comprising:
a hotel place page for the particular hotel in a first portion of the graphical user interface, the hotel place page comprising information identifying the particular hotel; and
a summary window for each of one or more candidate alternative hotels selected as alternative accommodations to the particular hotel in a second portion of the graphical user interface, the one or more candidate alternative hotels being selected by:
determining historical hotel data of the particular hotel over a specified time period;
determining current hotel data of the particular hotel for the particular date range;
calculating a score for the particular hotel, where the score is calculated using the historical hotel data and the current hotel data,
identifying a plurality of hotels that are each located within a specified distance from the particular hotel,
determining average historical hotel data for each identified hotel over the specified time period;
determining current hotel data for each identified hotel for the particular date range;
calculating a score for each identified hotel, where each of the scores is calculated using the average historical hotel data and the current hotel data of each identified hotel;
ranking, by the one or more processors, the candidate alternative hotels in the collection of candidate alternative hotels based at least in part on the respective scores for each of the candidate alternative hotels; and
selecting, by one or more user interface processors, one or more candidate alternative hotels from the collection of candidate alternative hotels having a rank exceeding a configured threshold as alternative accommodations to the particular hotel for presentation in the summary window of the second portion of the graphical user interface.

10. The computer storage of claim 9, where calculating the deal score comprises:
calculating a difference between the historical hotel data and the hotel actual price; and
dividing the difference by the historical hotel data.

11. The computer storage of claim 9, wherein the scores are used to generate advertising content for hotels with availability within the particular date range.

12. The computer storage of claim 9, wherein the graphical user interface displays the scores for the particular hotel and the one or more candidate alternative hotels.
